(19) United States
(12) Patent Application Publication
(10) Pub. No.: US 2024/0388670 A1
(43) Pub. Date: Nov. 21, 2024

(54) LIGHT SCANNING APPARATUS AND IMAGE FORMING APPARATUS

(71) Applicant: CANON KABUSHIKI KAISHA, Tokyo (JP)

(72) Inventors: Toshifumi CHIDA, Tochigi (JP); Kazumi KIMURA, Saitama (JP); Hayato KATO, Tochigi (JP)

(21) Appl. No.: 18/663,251

(22) Filed: May 14, 2024

(30) Foreign Application Priority Data
May 18, 2023 (JP) 2023-081949
Apr. 3, 2024 (JP) 2024-060052

(51) Int. Cl. H04N 1/028; H04N 1/00

(52) U.S. Cl. CPC H04N 1/0283; H04N 1/00254; H04N 1/02825

(57) ABSTRACT

A light scanning apparatus includes a deflecting unit deflecting a light flux from a light source to scan a scanned surface with light flux in a main scanning direction, and an optical system including a first optical element. The first optical element includes a transmissive surface transmitting a first light flux deflected by deflecting unit at a first timing to guide first light flux to scanned surface, and a reflective surface totally reflecting a second light flux deflected by deflecting unit at a second timing different from first timing to guide second light flux to a light receiving element. The reflective surface is arranged on the same side as light source with respect to a sub-scanning cross section including an optical axis of optical system, and the following inequality is satisfied:

$$\\ 55 ° \leq α \leq 75 °$$

where α represents an incident angle of a principal ray of second light flux to reflective surface.

### BACKGROUND OF THE INVENTION

### Field of the Invention

The present invention relates to a light scanning apparatus, which is particularly suitable for use in an image forming apparatus that uses an electrophotographic process, such as a laser beam printer and a multi-function printer.

### Description of the Related Art

Hitherto, for a light scanning apparatus, there has been used a configuration including an imaging optical system that guides a first light flux deflected by a deflecting unit onto a scanned surface and a synchronization detection optical system that guides a second light flux deflected by the deflecting unit to a synchronization detection unit.

In addition, it has been known that this type of light scanning apparatus increases in size depending on a relative arrangement between a light source that emits a light flux including the first light flux and the second light flux and the synchronization detection unit and a relative arrangement between the imaging optical system and the synchronization detection optical system.

In Japanese Patent Application Laid-Open No. H09-203872, there is disclosed a light scanning apparatus in which a light source and a synchronization detection unit are arranged close to each other and a reflective surface that reflects the above-mentioned second light flux is provided on an outer side, in a main scanning direction, of a region in an imaging optical element through which the above-mentioned first light flux passes, to thereby achieve suppression of the above-mentioned increase in size.

In the light scanning apparatus as disclosed in Japanese Patent Application Laid-Open No. H09-203872, in a case in which the second light flux deflected by a deflecting unit is guided to the synchronization detection unit arranged close to the light source, the reflective surface is provided to an inside of the imaging optical element at an end portion thereof on an opposite side from the light source in the main scanning direction.

The second light flux reflected by the reflective surface is guided to the synchronization detection unit after having passed throughout the inside of the imaging optical element in the main scanning direction, thereby adversely reducing a light amount of the second light flux received by a light receiving element included in the synchronization detection unit.

### SUMMARY OF THE INVENTION

Accordingly, an object of the present invention is to provide a small-size light scanning apparatus that can suppress a reduction in a light amount of a light flux guided to a light receiving element.

According to the present invention, there is provided a light scanning apparatus including: a deflecting unit configured to deflect a light flux from a light source so that a scanned surface is scanned with the light flux in a main scanning direction; and an optical system including a first optical element, wherein the first optical element includes: a transmissive surface configured to transmit a first light flux deflected by the deflecting unit at a first timing to guide the first light flux to the scanned surface; and a reflective surface configured to totally reflect a second light flux deflected by the deflecting unit at a second timing different from the first timing to guide the second light flux to a light receiving element, wherein the reflective surface is arranged on the same side as the light source with respect to a sub-scanning cross section including an optical axis of the optical system, and wherein the following inequality is satisfied:

$$\\ 55 ° \leq α \leq 75 °$$

where α represents an incident angle of a principal ray of the second light flux to the reflective surface.

Further features of the present invention will become apparent from the following description of exemplary embodiments with reference to the attached drawings.

### BRIEF DESCRIPTION OF THE DRAWINGS

FIG. 1 is a schematic main scanning cross-sectional view of a light scanning apparatus according to a first embodiment of the present invention.

FIG. 2 is a partially-enlarged schematic main scanning cross-sectional view of the light scanning apparatus according to the first embodiment.

FIG. 3 is a partially-enlarged schematic main scanning cross-sectional view of a light scanning apparatus according to a second embodiment of the present invention.

FIG. 4 is a partially-enlarged schematic main scanning cross-sectional view of a light scanning apparatus according to a third embodiment of the present invention.

FIG. 5 is a partially-enlarged schematic main scanning cross-sectional view of a light scanning apparatus according to a fourth embodiment of the present invention.

FIG. 6 is a partially-enlarged schematic main scanning cross-sectional view of a light scanning apparatus according to a fifth embodiment of the present invention.

FIG. 7 is a main-part sub-scanning cross-sectional view of an image forming apparatus according to the present invention.

### DESCRIPTION OF THE EMBODIMENTS

A light scanning apparatus according to the present invention is described in detail below with reference to the accompanying drawings. Some of the drawings referred to below may be drawn in scales different from the actual scale for easier understanding of the present invention.

In the following description, a main scanning direction refers to a direction perpendicular to a rotational axis of a deflecting unit and an optical axis of an imaging optical system (direction in which a light flux is deflected by the deflecting unit), and a sub-scanning direction refers to a direction parallel to the rotational axis of the deflecting unit. Further, a main scanning cross section refers to a cross section perpendicular to the sub-scanning direction, and a sub-scanning cross section refers to a cross section perpendicular to the main scanning direction.

In the following, a direction parallel to the optical axis of the imaging optical system is defined as an X direction, the main scanning direction is defined as a Y direction, and the sub-scanning direction is defined as a Z direction.

### First Embodiment

An image forming apparatus such as a laser printer is equipped with a light scanning apparatus for scanning a scanned surface with use of a laser beam.

This type of light scanning apparatus is provided with an optical element (fθ lens) for scanning which is used for scanning a scanned surface at a substantially constant speed and an optical system for synchronization detection which is used for specifying a writing start position on the scanned surface.

Further, in recent years, there has been proposed an optical system in which an optical element for scanning and an optical system for synchronization detection are integrated with each other in order to achieve a cost reduction and a size reduction of a light scanning apparatus.

There has been proposed a light scanning apparatus in which, for example, a deflecting portion is integrally provided to an optical element for scanning at an end portion thereof in a main scanning direction and a part of a light flux deflected by a deflecting unit is deflected by the deflecting portion to be guided to a synchronization detection unit after having passed throughout the optical element for scanning in the main scanning direction.

However, in this type of light scanning apparatus, a light flux passes through an inside of the optical element for scanning having a large width in the main scanning direction, and hence a light amount of the light flux received by the synchronization detection unit is reduced.

When the light amount is reduced, a drop occurs in accuracy of the writing start position on the scanned surface which is determined by the synchronization detection unit, and hence a drop may occur in image quality of an image formed on the scanned surface.

There has also been proposed a light scanning apparatus in which a deflecting portion having a total reflection surface is integrally provided to an optical element for scanning at an end portion thereof on an opposite side from a light source in the main scanning direction and a part of a light flux deflected by a deflecting unit is guided by the deflecting portion to a synchronization detection unit arranged on the opposite side.

However, in this type of light scanning apparatus, a part of the light flux deflected by the deflecting unit is deflected by the deflecting portion toward the synchronization detection unit arranged at a position greatly distanced from the light source, that is, on the opposite side from the light source in the main scanning direction.

Further, the deflecting portion is integrally formed to the optical element for scanning so as to be arranged on the opposite side from the light source with respect to a sub-scanning cross section including an optical axis of an imaging optical system, and hence the light scanning apparatus has not been reduced in size satisfactorily.

In addition, in this light scanning apparatus, the light source and the synchronization detection unit are greatly distanced from each other, and are required to be provided on mutually different substrates, thereby causing an increase in cost.

Accordingly, an object of the present invention is to provide a light scanning apparatus with which a size reduction, suppression of a drop in accuracy of a writing start position on a scanned surface, and a cost reduction have been achieved.

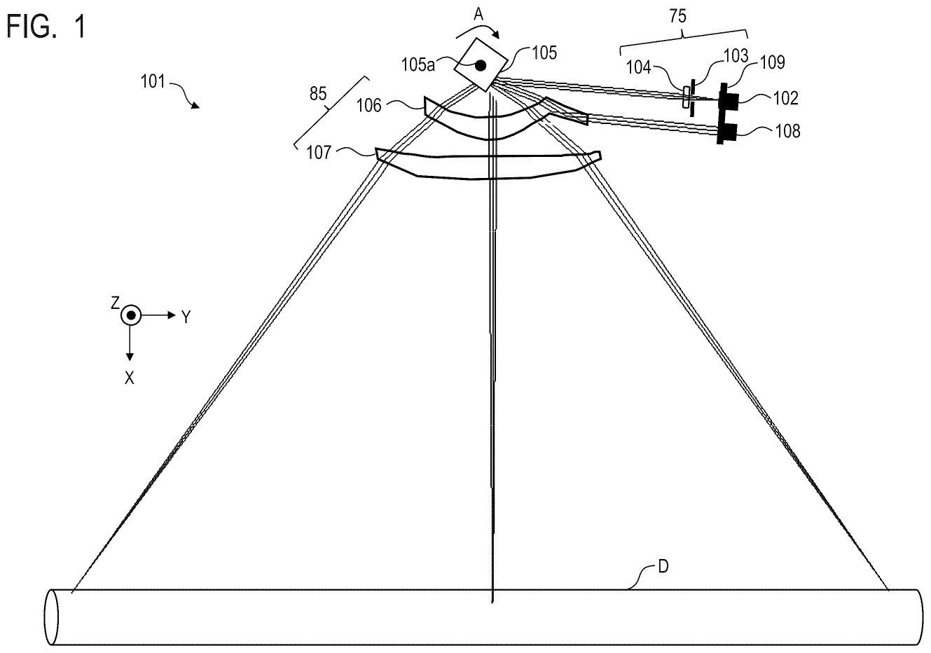

FIG. 1 shows a schematic main scanning cross-sectional view of a light scanning apparatus 101 according to the first embodiment of the present invention.

The light scanning apparatus 101 according to the first embodiment includes a light source 102, a stop 103, an anamorphic collimator lens 104 (second optical element), and a deflecting unit 105.

The light scanning apparatus 101 according to the first embodiment also includes a first optical element 106 for scanning (first optical element), a second optical element 107 for scanning, and a synchronization detection unit 108 (light receiving element).

The configuration described above enables the light scanning apparatus 101 according to the first embodiment to scan an entire scanned surface of a photosensitive drum D at a substantially constant speed in the main scanning direction.

The light source 102 is, for example, an edge emitting laser having one light emitting point for emitting a light flux having a wavelength of 780 nm, and is mounted on a substrate 109.

The stop 103 has an opening of a rectangular shape which restricts a light flux diameter of the light flux emitted from the light source 102 in each of the main scanning direction and the sub-scanning direction.

The anamorphic collimator lens 104 converts the light flux that has passed through the stop 103 into a parallel light flux in the main scanning direction. In this case, the parallel light flux is assumed to include not only a strict parallel light flux but also substantially parallel light fluxes such as a weakly divergent light flux and a weakly convergent light flux.

The anamorphic collimator lens 104 also condenses the light flux that has passed through the stop 103 toward the deflecting unit 105 in the sub-scanning direction.

In the light scanning apparatus 101 according to the first embodiment, the stop 103 and the anamorphic collimator lens 104 form an incident optical system 75.

Through provision of the anamorphic collimator lens 104 in this manner, the number of optical elements in the incident optical system 75 can be reduced, and a drop in accuracy of synchronization detection can be suppressed by suppressing interference of a light flux traveling through the synchronization detection optical system with respect to the incident optical system 75 as described later.

The light flux emitted from the light source 102 is then converted into a parallel light flux in a main scanning cross section by the incident optical system 75, and is condensed (guided) at a position close to a deflecting surface of the deflecting unit 105 in the sub-scanning cross section.

The deflecting unit 105 is a polygon mirror that has four deflecting surfaces and that deflects the light flux from the incident optical system 75 toward the scanned surface by rotating about a rotational axis 105a at a constant velocity in a direction A of FIG. 1.

The first optical element 106 for scanning and the second optical element 107 for scanning are optical elements that guide (condense) the light flux deflected by the deflecting unit 105 onto a scanned surface, and each have a shape that enables scanning of the scanned surface at a substantially constant speed in the main scanning direction.

In the light scanning apparatus 101 according to the first embodiment, the light flux emitted from the light source 102 is incident on (is guided to) the deflecting unit 105 by passing through the stop 103 and the anamorphic collimator lens 104.

The light flux deflected by the deflecting unit 105 is then guided onto the scanned surface by the first optical element 106 for scanning and the second optical element 107 for scanning, and an effective region (printed area) on the scanned surface is scanned with the light flux guided onto the scanned surface by rotation of the deflecting unit 105 at a constant velocity.

As described later in detail, the first optical element 106 for scanning provided to the light scanning apparatus 101 according to the first embodiment includes an optical portion S1 for scanning and a deflecting portion S2 for synchronization detection.

In the light scanning apparatus 101 according to the first embodiment, the optical portion S1 for scanning of the first optical element 106 for scanning and the second optical element 107 for scanning form an imaging optical system 85, and the light flux deflected by the deflecting unit 105 is guided onto the scanned surface by the imaging optical system 85.

In the light scanning apparatus 101 according to the first embodiment, the first optical element 106 for scanning is made of a resin material, and hence an exit surface 106b of the optical portion S1 for scanning and a total reflection surface 106d of the deflecting portion S2 for synchronization detection, which are described later, can be easily molded so as to be connected to each other.

The synchronization detection unit 108 is, for example, a photodetector such as a photodiode, and after a part of the light flux deflected by the deflecting unit 105 is incident on the synchronization detection unit 108, determines a scanning start position (writing start position) on the scanned surface based on a timing at which the incident light flux was received.

Specifically, the light source 102 is turned off until immediately before the deflecting unit 105 rotates to an angle at which to perform the synchronization detection, and the light source 102 is turned on when the synchronization detection is performed, that is, when the deflecting unit 105 reaches the angle.

After that, the light source 102 is turned off again, and after a lapse of a predetermined time determined by the synchronization detection unit 108, the light source 102 is turned on again when the deflecting unit 105 reaches a scanning start position, that is, an angle at which to start scanning on the scanned surface, to thereby cause the scanned surface to be scanned with the light flux.

That is, a controller (not shown) controls a light emission timing of the light source 102 based on the timing of reception, by the synchronization detection unit 108, of the light flux deflected by the deflecting unit 105.

With this setting, the same scanning start position on the scanned surface can be set for each time of scanning, to thereby be able to suppress a drop in image quality of an image formed on the scanned surface.

The synchronization detection unit 108 may include, in addition to the light receiving element that receives the incident light flux, a slit for improving accuracy of the scanning start position on the scanned surface to be determined.

In the light scanning apparatus 101 according to the first embodiment, as illustrated in FIG. 1, the synchronization detection unit 108 is mounted on the substrate 109 that is a common substrate shared with the light source 102.

That is, the light source 102 and the synchronization detection unit 108 are arranged on the same side with respect to the sub-scanning cross section including the optical axis of the imaging optical system 85.

The deflecting portion S2 for synchronization detection of the first optical element 106 for scanning forms a synchronization detection optical system that guides a part of the light flux deflected by the deflecting unit 105 to the synchronization detection unit 108 as described later.

That is, the first optical element 106 for scanning is shared by the imaging optical system 85 and the synchronization detection optical system.

Next, a characteristic configuration of the light scanning apparatus 101 according to the first embodiment is described.

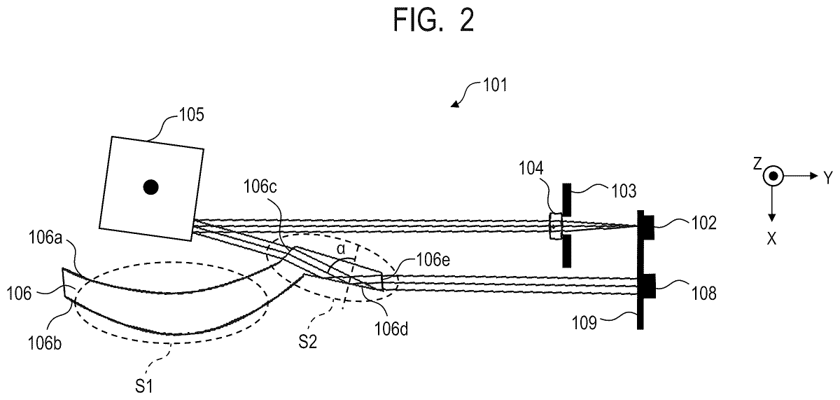

FIG. 2 shows a partially-enlarged schematic main scanning cross-sectional view of the light scanning apparatus 101 according to the first embodiment.

As illustrated in FIG. 2, the first optical element 106 for scanning provided to the light scanning apparatus 101 according to the first embodiment has the optical portion S1 for scanning that guides the light flux (first light flux) deflected by the deflecting unit 105 onto the scanned surface.

The first optical element 106 for scanning also includes the deflecting portion S2 for synchronization detection that deflects a part of the light flux (second light flux) deflected by the deflecting unit 105 toward the synchronization detection unit 108.

That is, the first optical element 106 for scanning is an optical element in which the optical portion S1 for scanning and the deflecting portion S2 for synchronization detection are formed integrally with each other.

Specifically, in the first optical element 106 for scanning, the deflecting portion S2 for synchronization detection is formed on the light source 102 side relative to the optical portion S1 for scanning.

The optical portion S1 for scanning has an incident surface 106a (second incident surface) and the exit surface 106b (second exit surface), and the deflecting portion S2 for synchronization detection has an incident surface 106c (first incident surface), the total reflection surface 106d (reflective surface), and an exit surface 106e (first exit surface).

That is, the incident surface 106a (first transmissive surface) and the exit surface 106b (second transmissive surface) of the optical portion S1 for scanning are transmissive surfaces (refractive surfaces) that guide the light flux deflected by the deflecting unit 105 at a first timing to the scanned surface by transmitting (refracting) the light flux through the transmissive surfaces.

In the first optical element 106 for scanning, the exit surface 106b and the total reflection surface 106d are connected to each other.

A critical angle of the total reflection surface 106d is 42.5°.

Further, specification values of the light scanning apparatus 101 according to the first embodiment are shown in Table 1 and Table 2 given below.

TABLE 1

| | Configuration of each member provided to light scanning apparatus 101 | | |
|---|---|---|---|
| Incident | Used wavelength of light source 102 | (nm) | 780 |
| optical | Number of light emitting points of light source 102 | N | 1 |
| system 75 | Distance between light emitting point of light source 102 and stop 103 | (mm) | 10.6 |
| | Distance between stop 103 and incident surface of anamorphic | (mm) | 0.5 |
| | collimator lens 104 | | |
| | Thickness of anamorphic collimator lens 104 | (mm) | 2 |
| | Refractive index of anamorphic collimator lens 104 | N1 | 1.805 |
| | Curvature radius of incident surface of anamorphic collimator lens | (mm) | 25.622 |
| | 104 in main scanning cross section | | |
| | Curvature radius of incident surface of anamorphic collimator lens | (mm) | 16.52 |
| | 104 in sub-scanning cross section | | |
| | Curvature radius of exit surface of anamorphic collimator lens 104 in | (mm) | −25.622 |
| | main scanning cross section | | |
| | Curvature radius of exit surface of anamorphic collimator lens 104 in | (mm) | ∞ |
| | sub-scanning cross section | | |
| | Distance between exit surface of anamorphic collimator lens 104 and | (mm) | 56.6 |
| | on-axis deflection point of deflecting unit 105 | | |
| Imaging | Distance between deflecting reference point of deflecting unit 105 | (mm) | 10.5 |
| optical | and incident surface of first optical element 106 for scanning | | |
| system 85 | Thickness of first optical element 106 for scanning | (mm) | 6.5 |
| | Refractive index of first optical element 106 for scanning | N3 | 1.524 |
| | Distance between exit surface of first optical element 106 for | (mm) | 7.12 |
| | scanning and incident surface of second optical element 107 for | | |
| | scanning | | |
| | Thickness of second optical element 107 for scanning | (mm) | 6.6 |
| | Refractive index of second optical element 107 for scanning | N4 | 1.524 |
| | Distance between on-axis deflection point of deflecting unit 105 and | (mm) | 134 |
| | scanned surface | | |
| Light | Focal length (fθ coefficient) of imaging optical system 85 in main | (mm/rad) | 130 |
| scanning | scanning cross section | | |
| apparatus | Effective scanning angle by deflecting unit 105 | θ (degrees) | ±28.1 |
| 101 | Effective scanning width on scanned surface | W (mm) | ±105 |
| | Angle between optical axis of incident optical system 75 and optical | θ (degrees) | 85 |
| | axis of imaging optical system 85 | | |
| | Number of deflecting surfaces of deflecting unit 105 | surfaces | 4 |
| | Circumradius of deflecting unit 105 | (mm) | 20 |

TABLE 2
Lens surface data of imaging optical system 85

| | | First optical element 106 for scanning | | | | | | | |
|---|---|---|---|---|---|---|---|---|---|
| | | | Incident | | Exit | Second optical element 107 for scanning | | | |
| | | Incident | surface | Exit | surface | | Incident | | Exit |
| | | surface | 106a | surface | 106b | Incident | surface | Exit | surface |
| | | 106a | (opposite- | 106b | (opposite- | surface | (opposite- | surface | (opposite- |
| | | (light | to-light- | (light | to-light- | (light | to-light- | (light | to-light- |
| | | source | source | source | source | source | source | source | source |
| | | side) | side) | side) | side) | side) | side) | side) | side) |
| Meridional | R | −2.648E+01 | −2.648E+01 | −1.975E+01 | −1.975E+01 | 8.480E+01 | 8.480E+01 | 8.257E+01 | 8.257E+01 |
| line | K | −1.499E+00 | −1.499E+00 | −8.115E−01 | −8.115E−01 | −8.430E+00 | −8.430E+00 | −8.260E−01 | −8.260E−01 |
| | B4 | 2.627E−05 | 2.627E−05 | 1.302E−05 | 1.222E−05 | −1.540E−05 | −1.717E−05 | −2.192E−05 | −2.315E−05 |
| | B6 | −5.638E−08 | −5.638E−08 | 3.590E−08 | 4.203E−08 | 1.374E−08 | 1.725E−08 | 2.453E−08 | 2.675E−08 |
| | B8 | 0.000E+00 | 0.000E+00 | −9.036E−11 | −9.982E−11 | −2.699E−12 | −4.670E−12 | −2.673E−11 | −2.921E−11 |
| | B10 | 0.000E+00 | 0.000E+00 | 0.000E+00 | 0.000E+00 | −2.155E−15 | −1.998E−15 | 2.102E−14 | 2.294E−14 |
| | B12 | 0.000E+00 | 0.000E+00 | 0.000E+00 | 0.000E+00 | 7.932E−19 | 7.717E−19 | −8.360E−18 | −8.509E−18 |
| | B14 | 0.000E+00 | 0.000E+00 | 0.000E+00 | 0.000E+00 | 0.000E+00 | 0.000E+00 | 1.048E−21 | 6.125E−22 |
| Sagittal | r | −1.160E+01 | −1.160E+01 | −3.000E+01 | −3.000E+01 | −7.888E+01 | −7.888E+01 | −1.006E+01 | −1.006E+01 |
| line | E2 | 1.668E−02 | −9.727E−05 | 4.743E−02 | −1.039E−02 | 4.132E−02 | 0.000E+00 | 1.772E−03 | 1.772E−03 |
| | E4 | −2.055E−05 | −7.391E−06 | −7.892E−04 | 8.822E−05 | −3.821E−05 | 0.000E+00 | −4.568E−06 | −4.568E−06 |
| | E6 | 0.000E+00 | 0.000E+00 | 5.729E−06 | −3.600E−07 | −1.215E−08 | 0.000E+00 | 6.292E−09 | 6.292E−09 |
| | E8 | 0.000E+00 | 0.000E+00 | −9.373E−09 | 5.306E−10 | 2.148E−11 | 0.000E+00 | −4.134E−12 | −4.134E−12 |
| | E10 | 0.000E+00 | 0.000E+00 | 0.000E+00 | 0.000E+00 | 0.000E+00 | 0.000E+00 | 1.055E−15 | 1.055E−15 |

In Table 2, “E-x” represents “×10^{-x}.”

Each of the incident surface 106a and the exit surface 106b of the optical portion S1 for scanning of the first optical element 106 for scanning and the incident surface and the exit surface of the second optical element 107 for scanning has an aspherical surface shape represented by the following expressions.

Specifically, respective meridional line shapes (shapes in the main scanning cross section) of the incident surface 106a and the exit surface 106b of the optical portion S1 for scanning of the first optical element 106 for scanning and the incident surface and the exit surface of the second optical element 107 for scanning are represented by Expression (1) and Expression (2).

$$\\ \begin{matrix}X = \frac{\frac{{Y}^{{}_{} 2}}{R}}{1 + \sqrt{1 - ( 1 + K ) {( \frac{Y}{R} )}^{2}}} + {B}_{4 s} {Y}^{{}_{} 4} + {B}_{6 s} {Y}^{{}_{} 6} + {B}_{8 s} {Y}^{{}_{} 8} + {B}_{10 s} {Y}^{{}_{} 10} + {B}_{12 s} {Y}^{{}_{} 12} + {B}_{14 s} {Y}^{{}_{} 14} & ( 1 )\end{matrix}$$

$$\\ \begin{matrix}X = \frac{\frac{{Y}^{{}_{} 2}}{R}}{1 + \sqrt{1 - ( 1 + K ) {( \frac{Y}{R} )}^{2}}} + {B}_{4 e} {Y}^{{}_{} 4} + {B}_{6 e} {Y}^{{}_{} 6} + {B}_{8 e} {Y}^{{}_{} 8} + {B}_{10 e} {Y}^{{}_{} 10} + {B}_{12 e} {Y}^{{}_{} 12} + {B}_{14 e} {Y}^{{}_{} 14} & ( 2 )\end{matrix}$$

In Expression (1) and Expression (2), a point of intersection between each optical surface and the optical axis is set as an origin.

Expression (1) represents a meridional line shape on the light source 102 side (hereinafter referred to as “light source side”) with respect to the sub-scanning cross section including the optical axis of the imaging optical system 85.

Expression (2) represents a meridional line shape on the side opposite to the light source 102 (hereinafter referred to as “opposite-to-light-source side”) with respect to the sub-scanning cross section including the optical axis of the imaging optical system 85.

Further, in Expression (1) and Expression (2), R represents a curvature radius (curvature radius of meridional line) in the main scanning cross section, and K, B₄, B₆, B₈, B₁₀, B₁₂, and B₁₄ represent aspherical surface coefficients.

B₄ₛ, B₆ₛ, B₈ₛ, B₁₀ₛ, B₁₂ₛ, and B₁₄ₛ in Expression (1) represent aspherical surface coefficients on the light source side (scanning start side), and B₄ₑ, B₆ₑ, B₈ₑ, B₁₀ₑ, B₁₂ₑ, and B₁₄ in Expression (2) represent aspherical surface coefficients on the opposite-to-light-source side (scanning end side).

That is, as shown in Table 2, the exit surface 106b of the optical portion S1 for scanning of the first optical element 106 for scanning, and the incident surface and the exit surface of the second optical element 107 for scanning have a meridional line shape asymmetrical with each other with respect to the optical axis of the imaging optical system 85.

Further, respective sagittal line shapes (shapes in the sub-scanning cross section) of the incident surface 106a and the exit surface 106b of the optical portion S1 for scanning of the first optical element 106 for scanning and the incident surface and the exit surface of the second optical element 107 for scanning are represented by Expression (3) and Expression (4).

$$\\ \begin{matrix}{r}^{{}_{} ′} ( Y ) = r ( 1 + {B}_{2 s} {Y}^{{}_{} 2} + {B}_{4 s} {Y}^{{}_{} 4} + {B}_{6 s} {Y}^{{}_{} 6} + {B}_{8 s} {Y}^{{}_{} 8} + {B}_{10 s} {Y}^{{}_{} 10} ) & ( 3 )\end{matrix}$$

$$\\ \begin{matrix}{r}^{{}_{} ′} ( Y ) = r ( 1 + {B}_{2 e} {Y}^{{}_{} 2} + {B}_{4 e} {Y}^{{}_{} 4} + {B}_{6 e} {Y}^{{}_{} 6} + {B}_{8 e} {Y}^{{}_{} 8} + {B}_{10 e} {Y}^{{}_{} 10} ) & ( 4 )\end{matrix}$$

Expression (3) represents a sagittal line shape on the light source side, and Expression (4) represents a sagittal line shape on the opposite-to-light-source side.

In Expression (3) and Expression (4), r′ represents a curvature radius (curvature radius of sagittal line) in the sub-scanning cross section, “r” represents a curvature radius of the sagittal line on the optical axis, and E₂, E₄, E₆, E₈, and E₁₀ represent aspherical surface coefficients.

E₂ₛ, E₄ₛ, E₆ₛ, E₈ₛ, and E₁₀ₛ in Expression (3) represent aspherical surface coefficients on the light source side (scanning start side), and E₂ₑ, E₄ₑ, E₆ₑ, E₈ₑ, and E₁₀ₑ in Expression (4) represent aspherical surface coefficients on the opposite-to-light-source side (scanning end side).

In the light scanning apparatus 101 according to the first embodiment, in a case of performing the synchronization detection, as illustrated in FIG. 2, the light flux from the light source 102 is deflected by the deflecting unit 105 at a second timing different from the above-mentioned first timing, and then is incident on the synchronization detection unit 108.

Specifically, as illustrated in FIG. 2, a part of the light flux deflected by the deflecting unit 105 is incident on the incident surface 106c of the deflecting portion S2 for synchronization detection of the first optical element 106 for scanning.

The light flux that has passed through the incident surface 106c of the deflecting portion S2 for synchronization detection is totally reflected by the total reflection surface 106d, and then exits from the exit surface 106e, to thereby be guided to the synchronization detection unit 108.

Thus, the scanned surface is scanned while the synchronization detection is performed for each deflecting surface of the deflecting unit 105.

As described above, in the first optical element 106 for scanning provided to the light scanning apparatus 101 according to the first embodiment, the deflecting portion S2 for synchronization detection is formed on the light source 102 side relative to the optical portion S1 for scanning.

In other words, in the first optical element 106 for scanning provided to the light scanning apparatus 101 according to the first embodiment, the total reflection surface 106d is provided on the same side as the light source 102 with respect to the sub-scanning cross section including the optical axis of the imaging optical system 85.

An angle between the incident surface 106c and the total reflection surface 106d is set to 65.9°, and an angle between the total reflection surface 106d and the exit surface 106e is set to 70.3°.

An angle between a traveling direction of the principal ray of the light flux deflected by the deflecting unit 105 and having passed through the incident surface 106c to the total reflection surface 106d and a normal of the total reflection surface 106d, that is, an incident angle α of the principal ray to the total reflection surface 106d is 69.2°.

Accordingly, the incident angle α is satisfactorily larger than the critical angle 42.5° of the total reflection surface 106d, and hence the light flux deflected by the deflecting unit 105 and having passed through the incident surface 106c is totally reflected by entering the total reflection surface 106d.

That is, in the light scanning apparatus 101 according to the first embodiment, Inequality (5) is satisfied.

$$\\ \begin{matrix}55 ° \leq α \leq 75 ° & ( 5 )\end{matrix}$$

In the light scanning apparatus 101 according to the first embodiment, it is possible to accomplish a cost reduction and a volume reduction of the deflecting portion S2 for synchronization detection by satisfying Inequality (5).

When a exceeds an upper limit value of Inequality (5), a light flux entering the total reflection surface 106d becomes excessively wider, with the result that the volume of the deflecting portion S2 for synchronization detection, and hence of the first optical element 106 for scanning increases, thereby causing an increase in cost, which is accordingly unpreferable.

When a falls below a lower limit value of Inequality (5), on the other hand, the angle formed by the light flux reflected by the total reflection surface 106d with respect to the total reflection surface 106d increases, thereby requiring the incident surface 106c to be provided so as to become wider.

As a result, an increase in volume of the deflecting portion S2 for synchronization detection causes an increase in cost, which is accordingly unpreferable.

In the light scanning apparatus 101 according to the first embodiment, it is preferred that Inequality (5a) be satisfied instead of Inequality (5).

$$\\ \begin{matrix}57 ° \leq α \leq 70 ° & ( 5 a )\end{matrix}$$

As described above, in the light scanning apparatus 101 according to the first embodiment, it is possible to form an inexpensive and small-size reflective surface in which a reflective film is not required to be provided as the total reflection surface 106d in the deflecting portion S2 for synchronization detection of the first optical element 106 for scanning.

Further, in the first optical element 106 for scanning, the deflecting portion S2 for synchronization detection is formed on the light source 102 side relative to the optical portion S1 for scanning, and hence it is possible to reduce a region in which the light flux traveling to the synchronization detection unit 108 passes through the first optical element 106 for scanning.

Accordingly, a reduction in the light amount of the light flux entering the synchronization detection unit 108 can be suppressed.

Further, in the deflecting portion S2 for synchronization detection of the first optical element 106 for scanning, the total reflection surface 106d provided as illustrated in FIG. 2 reflects the light flux so as to travel to the synchronization detection unit 108 arranged close to the light source 102.

With this setting, both the light source 102 and the synchronization detection unit 108 can be arranged on the substrate 109, and hence a component cost of the light scanning apparatus 101 according to the first embodiment can be reduced.

Further, an angle formed by an optical path of the principal ray of the light flux traveling through the incident optical system 75 in the main scanning cross section and an optical path of the principal ray of the light flux traveling through the synchronization detection optical system is represented by β.

In other words, the angle β is an angle formed in the main scanning cross section by a line segment between the emission point of the light source 102 and a deflection point on the deflecting surface of the deflecting unit 105 at a time of deflecting the principal ray of the light flux guided to the synchronization detection unit 108 and a line segment between an exit point of the principal ray on the exit surface 106e and a light receiving point of the principal ray of the synchronization detection unit 108.

In this case, in the light scanning apparatus 101 according to the first embodiment, it is preferred that Inequality (6) be satisfied.

$$\\ \begin{matrix}- 5 ° \leq β \leq 55 ° & ( 6 )\end{matrix}$$

A sign of the angle β is defined so that as the angle β becomes smaller, the above-mentioned light receiving point of the synchronization detection unit 108 shifts more toward a plus side in the X direction.

In the light scanning apparatus 101 according to the first embodiment, it is possible to reduce a size of the substrate 109 in the X direction by satisfying Inequality (6).

When β exceeds an upper limit value of Inequality (6) or falls below a lower limit value thereof, the synchronization detection unit 108 and the light source 102 are greatly distanced from each other in the X direction, thereby causing an increase in size of the substrate 109, which is accordingly unpreferable.

Further, when a folding mirror for folding the optical path in the sub-scanning direction is arranged on the downstream side of the first optical element 106 for scanning, mutual interference may occur between a holding member for holding the folding mirror and the substrate 109, which is accordingly unpreferable.

When β exceeds the upper limit value of Inequality (6), the incident angle of the light flux to the photodetector that forms the synchronization detection unit 108 increases, and hence an amount of light received by the synchronization detection unit 108 is reduced in accordance with an incident angle characteristic of the photodetector.

An attempt to increase a size of a light receiving region of the photodetector in accordance with such a reduction in the amount of received light causes a cost increase due to an increase in size of the photodetector, and is accordingly unpreferable.

In addition, when the incident angle of the light flux to the photodetector that forms the synchronization detection unit 108 increases, a light flux width of the light flux increases with respect to a light-receivable region of the photodetector, and the amount of light received by the photodetector is reduced, which is accordingly unpreferable.

In the light scanning apparatus 101 according to the first embodiment, it is more preferred that Inequality (6a) be satisfied instead of Inequality (6).

$$\\ \begin{matrix}- 2 ° \leq β \leq 45 ° & ( 6 a )\end{matrix}$$

In the light scanning apparatus 101 according to the first embodiment, β is set to 1°, and hence Inequalities (6) and (6a) are satisfied.

In the light scanning apparatus 101 according to the first embodiment, as illustrated in FIG. 2, the optical path of the principal ray of the light flux traveling through the incident optical system 75 and the optical path of the principal ray of the light flux traveling through the synchronization detection optical system do not intersect with each other when they are projected in the main scanning cross section.

Further, in the first optical element 106 for scanning, it is preferred that a gate cut portion (gate portion) (not shown) for injecting a resin material when injection molding is performed with the resin material be formed on the opposite-to-light-source side in the main scanning direction.

Thus, surface accuracy can be maintained in the first optical element 106 for scanning by molding an optical surface such as the exit surface 106e with high accuracy, and hence high optical performance can be obtained.

Further, in the light scanning apparatus 101 according to the first embodiment, it is preferred to provide the deflecting portion S2 for synchronization detection in the first optical element 106 for scanning which is closer to the deflecting unit 105 than the second optical element 107 for scanning.

In other words, it is preferred that no optical element for scanning be provided between the deflecting unit 105 and the optical element for scanning provided with the deflecting portion S2 for synchronization detection in an optical path (first optical path) of the light flux deflected by the deflecting unit 105 and then guided to the scanned surface.

When the deflecting portion S2 for synchronization detection is provided to the second optical element 107 for scanning, a light flux that has passed through the deflecting portion S2 for synchronization detection of the second optical element 107 for scanning after having passed through the first optical element 106 for scanning is incident on the synchronization detection unit 108.

That is, passing through the first optical element 106 for scanning further reduces the light amount of the light flux entering the synchronization detection unit 108, and is accordingly unpreferable.

As described above, in the light scanning apparatus 101 according to the first embodiment, in addition to the optical portion S1 for scanning, the deflecting portion S2 for synchronization detection is formed on the light source side relative to the optical portion S1 for scanning in the first optical element 106 for scanning.

Thus, the synchronization detection unit 108 can be provided on the same side as the light source 102 with respect to the sub-scanning cross section including the optical axis of the imaging optical system 85, and it is also possible to form the synchronization detection optical system only by the deflecting portion S2 for synchronization detection.

Accordingly, in the light scanning apparatus 101 according to the first embodiment, the reduction in the light amount of the light flux guided to the synchronization detection unit 108 can be suppressed, and a size reduction and a cost reduction can also be accomplished.

In the light scanning apparatus 101 according to the first embodiment, for example, an edge emitting laser having one light emitting point is used as the light source 102. However, the light source 102 is not limited thereto.

That is, an edge emitting laser having a plurality of light emitting points may be used as the light source 102, and a vertical cavity surface emitting laser (VCSEL) may be used.

Further, in the light scanning apparatus 101 according to the first embodiment, the light source 102 that emits a light flux having a wavelength of 780 nm is used as the light source 102. However, the light source 102 is not limited thereto, and a light source that emits a light flux having a predetermined wavelength may also be used.

Further, in the light scanning apparatus 101 according to the first embodiment, the stop 103 having an opening of a rectangular shape is used. However, the stop 103 is not limited thereto, and a stop having an opening of an elliptical shape or a polygonal shape may be used as the stop 103.

Further, in the light scanning apparatus 101 according to the first embodiment, the polygon mirror is used as the deflecting unit 105. However, the deflecting unit 105 is not limited thereto, and a reciprocating scanning mirror using a microelectromechanical system (MEMS) may also be used.

Further, in the light scanning apparatus 101 according to the first embodiment, the first optical element 106 for scanning and the second optical element 107 for scanning are formed with use of a glass material having a refractive index of 1.524. However, the present invention is not limited thereto, and a glass material having a predetermined refractive index may be used for the formation.

Further, in the light scanning apparatus 101 according to the first embodiment, the synchronization detection unit 108 is formed of the photodetector such as a photodiode. However, the synchronization detection unit 108 is not limited thereto, and may be formed of, for example, a combination of a photodetector and a slit having a predetermined width in the main scanning direction.

Further, in the light scanning apparatus 101 according to the first embodiment, the synchronization detection optical system is preferred not to be provided with an optical element for guiding a light flux to the synchronization detection unit 108 between the deflecting portion S2 for synchronization detection of the first optical element 106 for scanning and the synchronization detection unit 108.

In the light scanning apparatus 101 according to the first embodiment, a rib may be mounted to a casing (not shown) for holding a predetermined optical element, to thereby improve holding accuracy of the predetermined optical element.

In this case, the rib is preferred to be provided so as to suppress displacement in the X direction of the total reflection surface 106d of the deflecting portion S2 for synchronization detection, which is provided to the first optical element 106 for scanning.

Further, in order to suppress displacement in the Y direction of the exit surface 106e of the deflecting portion S2 for synchronization detection, which is provided to the first optical element 106 for scanning, a rib may be mounted at a position on a lower side in the Z direction than an effective region of the exit surface 106e from which a light flux exits.

Thus, the displacement of the exit surface 106e in the Y direction can be suppressed so as not to unnecessarily interfere with the light flux exiting from the exit surface 106e.

Further, in the light scanning apparatus 101 according to the first embodiment, it is preferred to cause the light flux to be incident on the exit surface 106e substantially perpendicularly so that aberrations due to eccentricity of each optical surface of the deflecting portion S2 for synchronization detection provided to the first optical element 106 for scanning do not occur.

Further, in the light scanning apparatus 101 according to the first embodiment, the total reflection surface 106d of the deflecting portion S2 for synchronization detection provided to the first optical element 106 for scanning may be formed as a curved surface within a range that satisfies a total reflection condition in accordance with a shape of the incident surface 106c.

Further, in the light scanning apparatus 101 according to the first embodiment, a folding mirror for folding an optical path in the sub-scanning direction may be provided.

In this case, the folding mirror is preferred to be arranged on the downstream side of the first optical element 106 for scanning, and a holding member that holds the folding mirror is also preferred to be provided.

### Second Embodiment

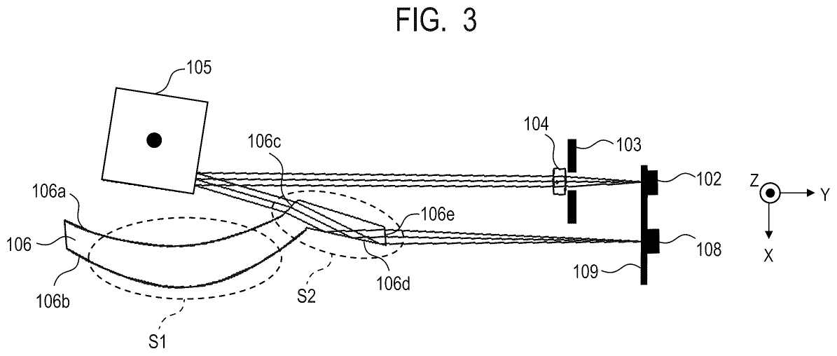

FIG. 3 shows a partially-enlarged schematic main scanning cross-sectional view of a light scanning apparatus according to a second embodiment of the present invention.

The light scanning apparatus according to the second embodiment has the same configuration as the configuration of the light scanning apparatus 101 according to the first embodiment, except that different specification values are used. Accordingly, the same members are denoted by the same reference numerals, and descriptions thereof are omitted.

Specifically, in the light scanning apparatus according to the second embodiment, the exit surface 106e provided to the deflecting portion S2 for synchronization detection of the first optical element 106 for scanning has a curvature in the main scanning cross section.

More specifically, the exit surface 106e provided to the deflecting portion S2 for synchronization detection is a convex surface having a curvature radius of 20 mm in the main scanning cross section, and is formed as an anamorphic surface having a power different from that in the sub-scanning cross section.

Thus, in the light scanning apparatus according to the second embodiment, the light flux exiting from the exit surface 106e can be guided to the synchronization detection unit 108 while being condensed, and hence synchronization detection accuracy in the synchronization detection unit 108 can be improved.

Further, in the light scanning apparatus according to the second embodiment as well, the deflecting portion S2 for synchronization detection is formed on the light source 102 side relative to the optical portion S1 for scanning in the first optical element 106 for scanning, and hence it is possible to reduce a region in which the light flux traveling to the synchronization detection unit 108 passes through the first optical element 106 for scanning.

Accordingly, the reduction in the light amount of the light flux entering the synchronization detection unit 108 can be suppressed.

The angle between the incident surface 106c and the total reflection surface 106d is set to 65.9°, and the angle between the total reflection surface 106d and the exit surface 106e is set to 70.3°.

The angle between the traveling direction of the principal ray of the light flux deflected by the deflecting unit 105 and having passed through the incident surface 106c to the total reflection surface 106d and the normal of the total reflection surface 106d, that is, the incident angle α of the principal ray to the total reflection surface 106d is 69.2°.

Accordingly, the incident angle is satisfactorily larger than the critical angle 42.5° of the total reflection surface 106d, and hence the light flux deflected by the deflecting unit 105 and having passed through the incident surface 106c is totally reflected by entering the total reflection surface 106d.

In the light scanning apparatus according to the second embodiment, the angle β is set to −1.5°, and hence Inequalities (5), (5a), (6), and (6a) are satisfied.

As described above, in the light scanning apparatus according to the second embodiment, in addition to the optical portion S1 for scanning, the deflecting portion S2 for synchronization detection is formed on the light source side relative to the optical portion S1 for scanning in the first optical element 106 for scanning.

Thus, the synchronization detection unit 108 can be provided on the same side as the light source 102 with respect to the sub-scanning cross section including the optical axis of the imaging optical system 85, and it is also possible to form the synchronization detection optical system only by the deflecting portion S2 for synchronization detection.

Further, in the light scanning apparatus according to the second embodiment, the light flux is guided to the synchronization detection unit 108 while being condensed.

Accordingly, in the light scanning apparatus according to the second embodiment, the reduction in the light amount of the light flux guided to the synchronization detection unit 108 can be suppressed, the synchronization detection accuracy in the synchronization detection unit 108 can be improved, and a size reduction and a cost reduction can also be achieved.

### Third Embodiment

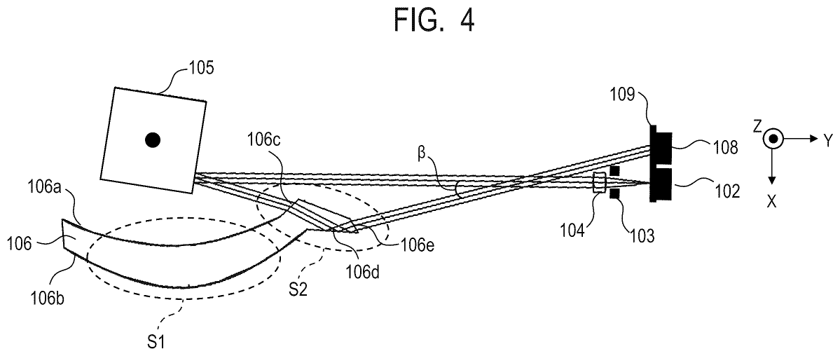

FIG. 4 shows a partially-enlarged schematic main scanning cross-sectional view of a light scanning apparatus according to a third embodiment of the present invention.

The light scanning apparatus according to the third embodiment has the same configuration as the configuration of the light scanning apparatus 101 according to the first embodiment, except that different specification values are used. Accordingly, the same members are denoted by the same reference numerals, and descriptions thereof are omitted.

Specifically, in the light scanning apparatus according to the third embodiment, a relative arrangement between the light source 102 and the synchronization detection unit 108 is different from that of the light scanning apparatus 101 according to the first embodiment.

More specifically, in the light scanning apparatus according to the third embodiment, the synchronization detection unit 108 is provided on the opposite side from the scanned surface with respect to a YZ cross section including the position of the light source 102 and being perpendicular to the optical axis of the imaging optical system 85.

Thus, as illustrated in FIG. 4, the light flux exiting from the exit surface 106e of the deflecting portion S2 for synchronization detection of the first optical element 106 for scanning is guided to the synchronization detection unit 108 so as to intersect with the light flux traveling through the incident optical system 75 when they are projected in the main scanning cross section.

That is, in the light scanning apparatus according to the third embodiment, the optical path of the principal ray of the light flux traveling through the incident optical system 75 and the optical path of the principal ray of the light flux traveling through the synchronization detection optical system are caused to intersect with each other when they are projected in the main scanning cross section.

Thus, the angle between the incident surface 106c and the total reflection surface 106d in the deflecting portion S2 for synchronization detection can be reduced.

Further, by reducing the angle between the incident surface 106c and the total reflection surface 106d, the light flux width of the light flux entering the total reflection surface 106d with respect to the total reflection surface 106d can be reduced.

Thus, the volume of the deflecting portion S2 for synchronization detection can be reduced in the first optical element 106 for scanning.

Accordingly, it is possible to further reduce a region in which a light flux passes through the first optical element 106 for scanning, to thereby be able to further suppress the reduction in the light amount of the light flux entering the synchronization detection unit 108.

In the light scanning apparatus according to the third embodiment, the anamorphic collimator lens 104 is preferred to be used to reduce the number of optical elements included in the incident optical system 75.

Thus, in a configuration in which the light flux traveling through the synchronization detection optical system and the light flux traveling through the incident optical system 75 are caused to intersect with each other, interference of the light flux traveling through the synchronization detection optical system with respect to an optical element included in the incident optical system 75 and a holding member of the optical element can be suppressed.

In the light scanning apparatus according to the third embodiment, a spacing between the light source 102 and the anamorphic collimator lens 104 is reduced by setting the focal length of the anamorphic collimator lens 104 to 7.4 mm.

With this setting, interference of the light flux traveling through the synchronization detection optical system with respect to the anamorphic collimator lens 104 can be suppressed.

In the light scanning apparatus according to the third embodiment, the angle β between the traveling direction of the principal ray of the light flux in the synchronization detection optical system and the traveling direction of the principal ray of the light flux in the incident optical system 75 in the main scanning cross section is set to 15°.

Further, the angle between the incident surface 106c and the total reflection surface 106d is set to 59.1°, and the angle between the total reflection surface 106d and the exit surface 106e is set to 55.2°.

The angle between the traveling direction of the principal ray of the light flux deflected by the deflecting unit 105 and having passed through the incident surface 106c to the total reflection surface 106d and the normal of the total reflection surface 106d, that is, the incident angle α of the principal ray to the total reflection surface 106d is 67.6°.

Accordingly, the incident angle α is satisfactorily larger than the critical angle 42.5° of the total reflection surface 106d, and hence the light flux deflected by the deflecting unit 105 and having passed through the incident surface 106c is totally reflected by entering the total reflection surface 106d.

As described above, in the light scanning apparatus according to the third embodiment, Inequalities (5), (5a), (6), and (6a) are satisfied.

As described above, in the light scanning apparatus according to the third embodiment, in addition to the optical portion S1 for scanning, the deflecting portion S2 for synchronization detection is formed on the light source side relative to the optical portion S1 for scanning in the first optical element 106 for scanning.

Thus, the synchronization detection unit 108 can be provided on the same side as the light source 102 with respect to the sub-scanning cross section including the optical axis of the imaging optical system 85, and it is also possible to form the synchronization detection optical system only by the deflecting portion S2 for synchronization detection.

Further, in the light scanning apparatus according to the third embodiment, the optical path of the principal ray of the light flux traveling through the incident optical system 75 and the optical path of the principal ray of the light flux traveling through the synchronization detection optical system are caused to intersect with each other when they are projected in the main scanning cross section.

Thus, in the light scanning apparatus according to the third embodiment, the reduction in the light amount of the light flux guided to the synchronization detection unit 108 can be further suppressed, and a size reduction and a cost reduction can also be achieved.

### Fourth Embodiment

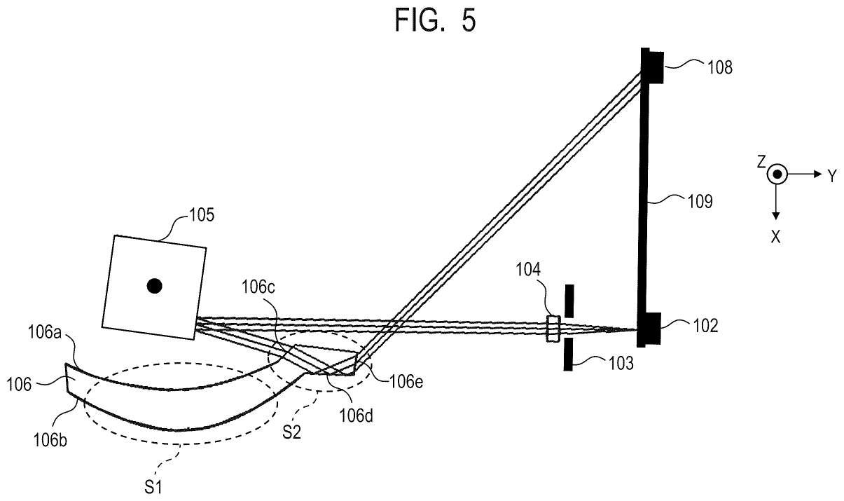

FIG. 5 shows a partially-enlarged schematic main scanning cross-sectional view of a light scanning apparatus according to a fourth embodiment of the present invention.

The light scanning apparatus according to the fourth embodiment has the same configuration as the configuration of the light scanning apparatus 101 according to the first embodiment, except that different specification values are used. Accordingly, the same members are denoted by the same reference numerals, and descriptions thereof are omitted.

In the light scanning apparatus according to the fourth embodiment, a spacing between the light source 102 and the synchronization detection unit 108 is increased as compared to the light scanning apparatus according to the third embodiment.

An angle between the total reflection surface 106d and the exit surface 106e is then adjusted in accordance with the increase in the spacing, to thereby adjust an exit angle of the light flux from the exit surface 106e.

Specifically, the angle between the total reflection surface 106d and the exit surface 106e is adjusted so that the angle β between the traveling direction of the principal ray of the light flux in the synchronization detection optical system and the traveling direction of the principal ray of the light flux in the incident optical system 75 in the main scanning cross section becomes 45 degrees.

In the light scanning apparatus according to the fourth embodiment, the angle between the incident surface 106c and the total reflection surface 106d is set to 57.6°, and the angle between the total reflection surface 106d and the exit surface 106e is set to 96.3°.

The angle between the traveling direction of the principal ray of the light flux deflected by the deflecting unit 105 and having passed through the incident surface 106c to the total reflection surface 106d and the normal of the total reflection surface 106d, that is, the incident angle α of the principal ray to the total reflection surface 106d is 61.5°.

Accordingly, the incident angle α is satisfactorily larger than the critical angle 42.5° of the total reflection surface 106d, and hence the light flux deflected by the deflecting unit 105 and having passed through the incident surface 106c is totally reflected by entering the total reflection surface 106d.

As described above, in the light scanning apparatus according to the fourth embodiment, Inequalities (5), (5a), (6), and (6a) are satisfied.

As described above, in the light scanning apparatus according to the fourth embodiment, in addition to the optical portion S1 for scanning, the deflecting portion S2 for synchronization detection is formed on the light source side relative to the optical portion S1 for scanning in the first optical element 106 for scanning.

Thus, the synchronization detection unit 108 can be provided on the same side as the light source 102 with respect to the sub-scanning cross section including the optical axis of the imaging optical system 85, and it is also possible to form the synchronization detection optical system only by the deflecting portion S2 for synchronization detection.

Further, in the light scanning apparatus according to the fourth embodiment, the optical path of the principal ray of the light flux traveling through the incident optical system 75 and the optical path of the principal ray of the light flux traveling through the synchronization detection optical system are caused to intersect with each other when they are projected in the main scanning cross section.

Thus, in the light scanning apparatus according to the fourth embodiment, the reduction in the light amount of the light flux guided to the synchronization detection unit 108 can be further suppressed, and a size reduction and a cost reduction can also be achieved.

### Fifth Embodiment

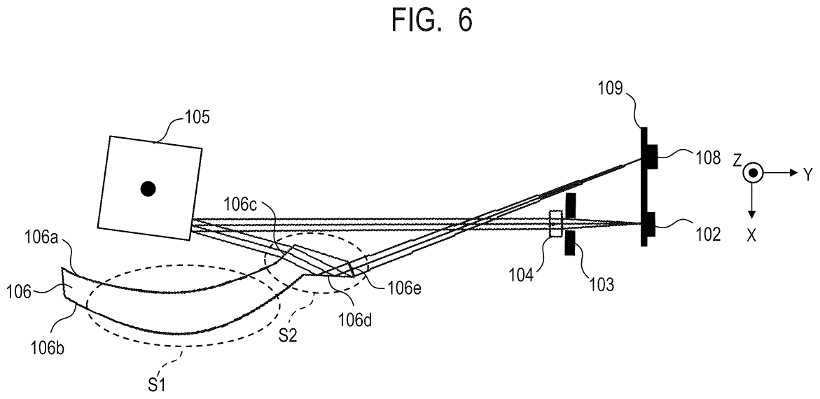

FIG. 6 shows a partially-enlarged schematic main scanning cross-sectional view of a light scanning apparatus according to a fifth embodiment of the present invention.

The light scanning apparatus according to the fifth embodiment has the same configuration as the configuration of the light scanning apparatus 101 according to the first embodiment, except that different specification values are used. Accordingly, the same members are denoted by the same reference numerals, and descriptions thereof are omitted.

In the light scanning apparatus according to the fifth embodiment, the synchronization detection unit 108 is provided on the opposite side from the scanned surface with respect to the YZ cross section including the position of the light source 102 and being perpendicular to the optical axis of the imaging optical system 85.

Specifically, the angle β between the traveling direction of the principal ray of the light flux in the synchronization detection optical system and the traveling direction of the principal ray of the light flux in the incident optical system 75 in the main scanning cross section is set to 20°.

Further, in the light scanning apparatus according to the fifth embodiment, the exit surface 106e of the deflecting portion S2 for synchronization detection of the first optical element 106 for scanning is formed so as to have a curvature in the main scanning cross section.

Thus, the light flux exiting from the exit surface 106e can be guided to the synchronization detection unit 108 while being condensed, and hence the synchronization detection accuracy in the synchronization detection unit 108 can be improved.

The angle between the incident surface 106c and the total reflection surface 106d is set to 52.1°, and the angle between the total reflection surface 106d and the exit surface 106e is set to 65.6°.

The angle between the traveling direction of the principal ray of the light flux deflected by the deflecting unit 105 and having passed through the incident surface 106c to the total reflection surface 106d and the normal of the total reflection surface 106d, that is, the incident angle α of the principal ray to the total reflection surface 106d is 58.2°.

Accordingly, the incident angle is satisfactorily larger than the critical angle 42.5° of the total reflection surface 106d, and hence the light flux deflected by the deflecting unit 105 and having passed through the incident surface 106c is totally reflected by entering the total reflection surface 106d.

As described above, in the light scanning apparatus according to the fifth embodiment, Inequalities (5), (5a), (6), and (6a) are satisfied.

As described above, in the light scanning apparatus according to the fifth embodiment, in addition to the optical portion S1 for scanning, the deflecting portion S2 for synchronization detection is formed on the light source side relative to the optical portion S1 for scanning in the first optical element 106 for scanning.

Thus, the synchronization detection unit 108 can be provided on the same side as the light source 102 with respect to the sub-scanning cross section including the optical axis of the imaging optical system 85, and it is also possible to form the synchronization detection optical system only by the deflecting portion S2 for synchronization detection.

Further, in the light scanning apparatus according to the fifth embodiment, the light flux is guided to the synchronization detection unit 108 while being condensed.

Further, in the light scanning apparatus according to the fifth embodiment, the optical path of the principal ray of the light flux traveling through the incident optical system 75 and the optical path of the principal ray of the light flux traveling through the synchronization detection optical system are caused to intersect with each other when they are projected in the main scanning cross section.

Thus, in the light scanning apparatus according to the fifth embodiment, the reduction in the light amount of the light flux guided to the synchronization detection unit 108 can be further suppressed, the synchronization detection accuracy in the synchronization detection unit 108 can be improved, and a size reduction and a cost reduction can be also achieved.

Specification values of the deflecting portion S2 for synchronization detection of the first optical element 106 for scanning provided to each of the light scanning apparatus according to the first to fifth embodiments described above are shown in Table 3.

TABLE 3

| Deflecting portion S2 for | | First | Second | Third | Fourth | Fifth |
|---|---|---|---|---|---|---|
| synchronization detection | | embodiment | embodiment | embodiment | embodiment | embodiment |
| Angle between | (degrees) | 65.9 | 65.9 | 59.1 | 57.6 | 52.1 |
| incident | | | | | | |
| surface 106c | | | | | | |
| and total | | | | | | |
| reflection | | | | | | |
| surface 106d | | | | | | |
| Incident angle | (degrees) | 69.2 | 69.2 | 67.6 | 61.5 | 58.2 |
| of the light flux | | | | | | |
| to total | | | | | | |
| reflection | | | | | | |
| surface 106d | | | | | | |
| Angle between | (degrees) | 70.3 | 70.3 | 55.2 | 96.3 | 65.6 |
| total reflection | | | | | | |
| surface 106d | | | | | | |
| and exit surface | | | | | | |
| 106e | | | | | | |
| Curvature | (mm) | ∞ | 20 | ∞ | ∞ | 23.2 |
| radius of exit | | | | | | |
| surface 106e in | | | | | | |
| main scanning | | | | | | |
| cross section | | | | | | |
| Curvature | (mm) | 8.9 | 8.9 | 8.4 | 14.5 | 8.7 |
| radius of exit | | | | | | |
| surface 106e in | | | | | | |
| sub-scanning | | | | | | |
| cross section | | | | | | |

According to the present invention, a small-size light scanning apparatus that can suppress the reduction in the light amount of the light flux guided to the light receiving element can be provided.

### Image Forming Apparatus

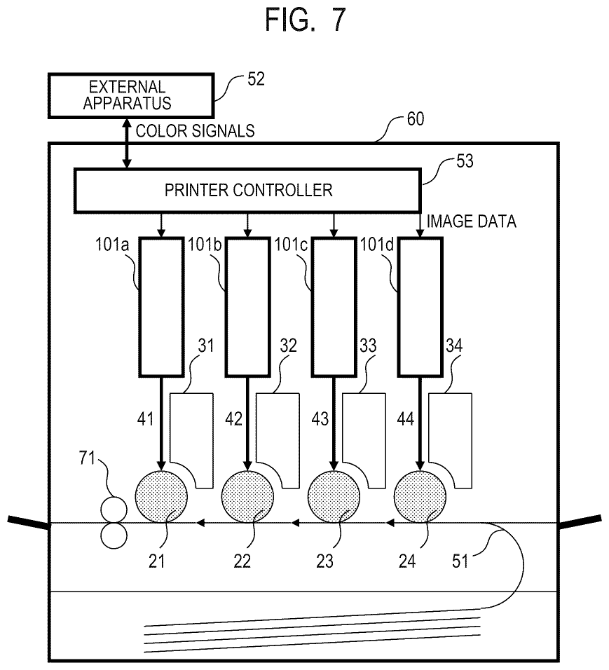

FIG. 7 shows a main-part sub-scanning cross-sectional view of a color image forming apparatus 60 including light scanning apparatuses 101a, 101b, 101c, and 101d according to any one of the first to fifth embodiments.

The color image forming apparatus 60 is, for example, an image forming apparatus that records image information on a photosensitive drum.

The color image forming apparatus 60 includes photosensitive drums 21, 22, 23, and 24, developing units 31, 32, 33, and 34, a conveying belt 51, a printer controller 53, a fixing unit 71, and the light scanning apparatuses 101a, 101b, 101c, and 101d.

As illustrated in FIG. 7, respective color signals of red (R), green (G), and blue (B) output from an external apparatus 52 such as a personal computer are input to the color image forming apparatus 60.

Then, the input color signals are converted into respective pieces of image data (screen pattern) of cyan (C), magenta (M), yellow (Y), and black (K) by the printer controller 53.

The respective pieces of image data obtained by the conversion are input to the light scanning apparatuses 101a, 101b, 101c, and 101d.

Subsequently, light beams 41, 42, 43, and 44 modulated in accordance with the respective pieces of image data are emitted from the light scanning apparatuses 101a, 101b, 101c, and 101d, respectively.

Then, the light beams 41, 42, 43, and 44 scan on photosensitive surfaces of the photosensitive drums 21, 22, 23, and 24 in the main scanning direction, respectively.

In the color image forming apparatus 60, the light scanning apparatuses 101a to 101d correspond to colors of cyan (C), magenta (M), yellow (Y), and black (K), respectively, and records the image signals on the photosensitive surfaces of the photosensitive drums 21 to 24 in parallel to each other, to thereby print a color image at a high speed.

In the color image forming apparatus 60, as described above, the light beams 41 to 44 based on the respective pieces of image data emitted from the four light scanning apparatuses 101a to 101d are used to form electrostatic latent images of the respective colors on the photosensitive surfaces of the respective photosensitive drums 21 to 24 corresponding thereto.

Specifically, each of the photosensitive drums 21 to 24 is uniformly charged with a voltage applied thereto.

Then, the light beams 41 to 44 irradiate the photosensitive surfaces of the photosensitive drums 21 to 24 uniformly charged in such a manner, to thereby lower only the voltage of an irradiation portion.

A voltage distribution formed on each of the photosensitive surfaces of the photosensitive drums 21 to 24 in this manner is an electrostatic latent image.

After that, the electrostatic latent images of the respective colors are developed into toner images of the respective colors by the developing units 31, 32, 33, and 34, and the developed toner images of the respective colors are multiply transferred, by a transferring unit (not shown), onto a transferred material conveyed by the conveying belt 51.

Then, the transferred toner images are fixed by the fixing unit 71, and one full-color image is formed.

In this manner, the color image forming apparatus 60 is mounted with the light scanning apparatuses 101a, 101b, 101c, and 101d according to any one of the first to fifth embodiments, to thereby be able to suppress a drop in image quality of an image to be formed.

As the external apparatus 52, for example, a color image reading apparatus including a charge coupled device (CCD) sensor may be used.

In this case, the color image reading apparatus and the color image forming apparatus 60 form a color digital copying machine.

The light scanning apparatus according to any one of the first to fifth embodiments can be used in not only the color image forming apparatus 60 but also a monochrome image forming apparatus.

In this case, one light scanning apparatus according to any one of the first to fifth embodiments may be provided to the monochrome image forming apparatus.

The exemplary embodiments of the present invention are described above, but the present invention is not limited to these embodiments and can be modified and changed variously within the scope of the gist thereof.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-081949, filed May 18, 2023, and Japanese Patent Application No. 2024-060052, filed Apr. 3, 2024, which are hereby incorporated by reference herein in their entirety.

What is claimed is:

1. A light scanning apparatus comprising:
a deflecting unit configured to deflect a light flux from a light source so that a scanned surface is scanned with the light flux in a main scanning direction; and
an optical system including a first optical element,
wherein the first optical element includes:
a transmissive surface configured to transmit a first light flux deflected by the deflecting unit at a first timing to guide the first light flux to the scanned surface; and
a reflective surface configured to totally reflect a second light flux deflected by the deflecting unit at a second timing different from the first timing to guide the second light flux to a light receiving element,
wherein the reflective surface is arranged on the same side as the light source with respect to a sub-scanning cross section including an optical axis of the optical system, and
wherein the following inequality is satisfied:
$$\\ 55 ° \leq α \leq 75 °$$
where α represents an incident angle of a principal ray of the second light flux to the reflective surface.

2. The light scanning apparatus according to claim 1, further comprising a controller configured to control a light emission timing of the light source based on a timing of reception of the second light flux by the light receiving element.

3. The light scanning apparatus according to claim 1, wherein an optical path between the deflecting unit and the first optical element is free from an optical element configured to guide the first light flux.

4. The light scanning apparatus according to claim 1, wherein the light source and the light receiving element are provided on a common substrate.

5. The light scanning apparatus according to claim 1, wherein the following inequality is satisfied:
$$\\ - 5 ° \leq β \leq 55 °$$
where β represents an angle formed by an optical path between the light source and the deflecting unit and an optical path between the first optical element and the light receiving element when they are projected in a main scanning cross section.

6. The light scanning apparatus according to claim 5, wherein the optical path between the light source and the deflecting unit and the optical path between the first optical element and the light receiving element intersect with each other when they are projected in the main scanning cross section.

7. The light scanning apparatus according to claim 1, wherein the first optical element includes an incident surface through which the second light flux deflected by the deflecting unit is incident on the first optical element and an exit surface through which the second light flux reflected by the reflective surface exits from the first optical element.

8. The light scanning apparatus according to claim 1,
wherein the first optical element includes a first transmissive surface through which the first light flux deflected by the deflecting unit is incident on the first optical element and a second transmissive surface through which the first light flux that has been incident on the first optical element through the first transmissive surface exits from the first optical element, and
wherein the second transmissive surface and the reflective surface are connected to each other.

9. The light scanning apparatus according to claim 1, wherein an optical path between the first optical element and the light receiving element is free from an optical element configured to guide the second light flux.

10. The light scanning apparatus according to claim 1, wherein the first optical element is made of a resin material.

11. The light scanning apparatus according to claim 1, wherein the first optical element has formed therein a gate portion on an opposite side from the light source with respect to the sub-scanning cross section including the optical axis.

12. The light scanning apparatus according to claim 1, further comprising a second optical element configured to convert the light flux emitted from the light source into a parallel light flux in a main scanning cross section and condense the light flux in the sub-scanning cross section.

13. An image forming apparatus comprising:
the light scanning apparatus of claim 1;
a developing unit configured to develop, as a toner image, an electrostatic latent image formed on the scanned surface by the light scanning apparatus;
a transferring unit configured to transfer the developed toner image onto a transferred material; and
a fixing unit configured to fix the transferred toner image on the transferred material.

14. An image forming apparatus comprising:
the light scanning apparatus of claim 1; and
a printer controller configured to convert a signal output from an external apparatus into image data to input the image data to the light scanning apparatus.
